(19) United States
(12) Patent Application Publication
(10) Pub. No.: US 2017/0103548 A1
(43) Pub. Date: Apr. 13, 2017

(54) VEHICLE-MOUNTED DISPLAY DEVICE, METHOD FOR CONTROLLING VEHICLE-MOUNTED DISPLAY DEVICE, AND PROGRAM

(71) Applicant: Panasonic Intellectual Property Management Co., Ltd., Osaka (JP)

(72) Inventor: TAKASHI TAJIMA, Osaka (JP)

(73) Assignee: Pansonic Intellectual Property Manamagement Co., Ltd., Osaka (JP)

(21) Appl. No.: 15/129,419

(22) PCT Filed: Feb. 27, 2015
(86) PCT No.: PCT/JP2015/001026

§ 371 Date: Sep. 27, 2016

(30) Foreign Application Priority Data
Mar. 27, 2014 (JP) 2014-065179

(51) Int. Cl. G06T 11/00; G06T 11/60; G09G 5/02; B60K 35/00

(52) U.S. Cl. CPC G06T 11/001; B60K 35/00; G06T 11/60; G09G 5/024; B60K 2350/2008; B60K 2350/2069; G06T 2207/20212

(57) ABSTRACT

A vehicle-mounted display device includes an input unit, a foreground image acquisition unit, a brightness value calculation unit, a background image conversion unit, a combining unit, and a display unit. The foreground image acquisition unit acquires a foreground image including vehicle information. The brightness value calculation unit calculates a brightness value of a background image input from the input unit. The background image conversion unit converts the background image input from the input unit in accordance with the brightness value of the background image and color information of a theme color. The combining unit combines the foreground image and the background image converted by the background image conversion unit, and the display unit displays an image combined by the combining unit.

### TECHNICAL FIELD

The present invention relates to a vehicle-mounted display device for displaying a background image specified by a user.

### BACKGROUND ART

Instruments, such as speedometer, displayed on a liquid crystal display have been used in vehicles in recent years. In addition to a front panel in a cockpit, a user has been able to touch operate an air conditioner and other equipment with buttons displayed on such a liquid crystal display.

In such a case, the user may want to use his or her favorite image as a background image on the speedometer or other instruments.

A known conventional vehicle-mounted display device for displaying a background image specified by a user (for example, a vehicle instrument having a display) is shown below (for example, see Patent Literature 1). To prevent visibility of a foreground image, such as a speedometer and other instruments, from being reduced when a background image is displayed, the vehicle-mounted display device warns a user if the user has specified a background image having a color similar to a color of a foreground image to prompt the user to change the background image to another one.

### CITATION LIST

### Patent Literature

PTL 1: Unexamined Japanese Patent Publication No. 2005-88673

### SUMMARY OF THE INVENTION

The present invention provides a vehicle-mounted display device offering a sense of uniformity on a whole display screen so that a background screen that does not reduce visibility of a foreground image is displayed regardless of whether the background image has a color similar to a color of the foreground image.

A vehicle-mounted display device according to the present invention includes an input unit, a foreground image acquisition unit, a brightness value calculation unit, a background image conversion unit, a combining unit, and a display unit. The foreground image acquisition unit acquires a foreground image including vehicle information. The brightness value calculation unit calculates a brightness value of a background image input from the input unit. The background image conversion unit converts the background image input from the input unit in accordance with the brightness value of the background image and color information of a theme color. The combining unit combines the foreground image and the background image converted by the background image conversion unit, and the display unit displays an image combined by the combining unit.

A theme color is referred to as a color that represents a basic tone of a display screen, and is used to provide a sense of uniformity on the display screen. The color includes a color of a frame of a button of a display audio disposed in a vehicle. The theme color differs depending on, for example, a vehicle type. Vehicle information includes information regarding a vehicle, such as states of fuel, engine speed, vehicle speed, and an air conditioner, as well as information regarding equipment mounted in the vehicle, such as a clock, a radio, and an audio.

According to the present invention, a sense of uniformity can be provided on a whole display screen so that a background screen that does not reduce visibility of a foreground image is displayed regardless of whether a background image has a color similar to a color of the foreground image.

### BRIEF DESCRIPTION OF DRAWINGS

FIG. 1 is a block diagram illustrating a configuration of vehicle-mounted display device 100 according to an exemplary embodiment of the present invention.

FIG. 2 is a flow chart illustrating an exemplary operation of vehicle-mounted display device 100 according to the exemplary embodiment of the present invention.

FIG. 3 is a flow chart illustrating an exemplary operation, after a background image is converted, of vehicle-mounted display device 100 according to the exemplary embodiment of the present invention.

FIG. 4 is a view of an exemplary foreground image, according to the exemplary embodiment of the present invention.

FIG. 5 is a view of an exemplary user image to be treated as a background image, according to the exemplary embodiment of the present invention.

FIG. 6 is a view illustrating an image in which foreground image 400 and background image 500 are simply combined, according to the exemplary embodiment of the present invention.

FIG. 7 is a view illustrating an exemplary background image converted by background image conversion unit 1035 according to the exemplary embodiment of the present invention.

FIG. 8 is a view illustrating an image in which converted background image 700 and foreground image 400 are combined, according to the exemplary embodiment of the present invention.

FIG. 9 is a view illustrating another example of the converted background image, according to the exemplary embodiment of the present invention.

FIG. 10 is a view illustrating an image in which converted background image 900 and foreground image 400 are combined, according to the exemplary embodiment of the present invention.

### DESCRIPTION OF EMBODIMENT

Before describing an exemplary embodiment of the present invention, problems found in a conventional vehicle-mounted display device will now be described herein. Such a conventional vehicle-mounted display device is mainly focused on visibility, and is not fully provided with a sense of uniformity on a whole display. Such a feature could reduce visibility of a foreground image when a background image is displayed, even though the background image does not has a color similar to a color of the foreground image.

The exemplary embodiment of the present invention will now be described herein with reference to the respective drawings. The exemplary embodiment of the present invention described below also shows a preferable example of the present invention. Each of numerical values, shapes, components, arrangements of the components, coupling styles, and others shown in the exemplary embodiment are just an example, and does not intend to limit the present invention. The present invention is only limited by the claims. Therefore, components that are not included in independent claims, among components included in the exemplary embodiment described below, will be described such that the components configure a preferable form of the present invention, although the components are not necessarily required to solve problems and achieve an object of the present invention.

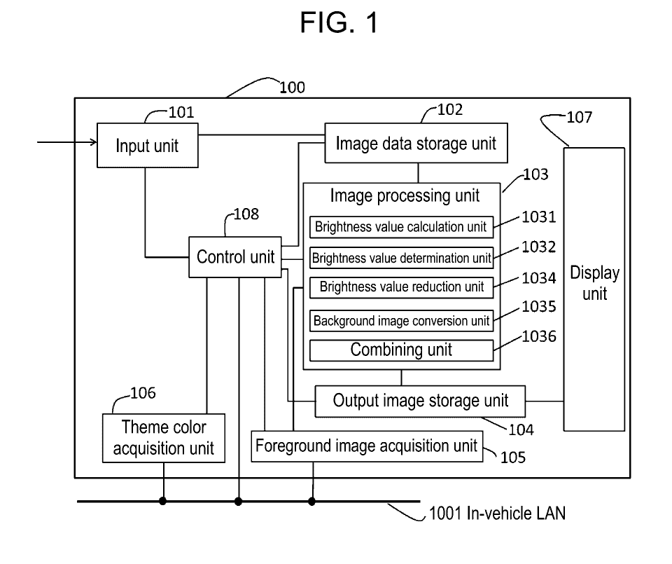

FIG. 1 is a block diagram illustrating a configuration of a vehicle-mounted display device according to a first exemplary embodiment of the present invention.

In FIG. 1, vehicle-mounted display device 100 is coupled to in-vehicle LAN 1001. Various electronic control units (ECUs), such as an engine ECU, are coupled to in-vehicle LAN (Controller Area Network) 1001. Vehicle-mounted display device 100 acquires information regarding a vehicle via in-vehicle LAN 1001 to display the information.

Input unit 101 allows a user to input a user image for use as a background image. Input unit 101 has, for example, a Bluetooth (registered trademark) communication function to accept an input of the background image via a Bluetooth communication. Image data storage unit 102 stores the background image input from input unit 101.

Image processing unit 103 converts the background image so that the background image is displayed on display unit 107, and generates a display image from the converted background image and a foreground image. Image processing unit 103 includes brightness value calculation unit 1031, brightness value determination unit 1032, brightness value reduction unit 1034, background image conversion unit 1035, and combining unit 1036.

Brightness value calculation unit 1031 calculates a brightness value of the background image. Brightness value determination unit 1032 determines whether the calculated brightness value of the background image is equal to or above a predetermined threshold. Brightness value reduction unit 1034 reduces the brightness value of the background image. Background image conversion unit 1035 converts the background image using the brightness value of the background image and color information of a theme color. Combining unit 1036 combines the foreground image and the background image converted by background image conversion unit 1035 to generate a display image.

Output image storage unit 104 stores the display image generated by image processing unit 103. Foreground image acquisition unit 105 acquires via in-vehicle LAN 1001 an foreground image including information regarding a vehicle, such as images displaying states of a fuel meter, a tachometer, and an air conditioner, as well as information regarding equipment mounted in the vehicle, such as a clock, a radio, and an audio.

Theme color acquisition unit 106 acquires via in-vehicle LAN 1001, for example, a color of a frame of a button of a display audio as a theme color. Display unit 107 displays the display image generated by image processing unit 103. Display unit 107 is configured with, for example, a liquid crystal panel.

Control unit 108 controls a whole vehicular display device. Control unit 108 includes a central processing unit (CPU) controlling operations of units such as units ranging from input unit 101 to display unit 107, a read only memory (ROM) storing control programs, and a random access memory (RAM) storing control data and data to be held temporarily.

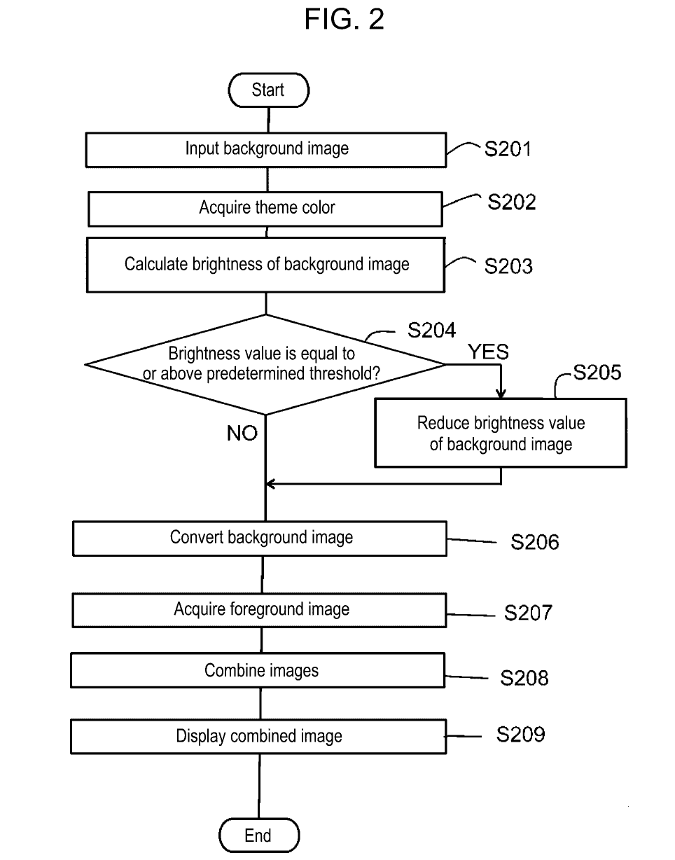

Based on vehicle-mounted display device 100 according to the first exemplary embodiment configured as described above, major operations with regard to the present invention will now be described herein. FIG. 2 is a flow chart illustrating an exemplary operation of vehicle-mounted display device 100 according to the first exemplary embodiment.

A user who has specified an area of display unit 107, onto which a foreground image and a background image will be displayed, inputs the background image from input unit 101 (step S201). The input background image is stored in image data storage unit 102. Theme color acquisition unit 106 acquires a theme color via in-vehicle LAN 1001 (step S202).

Brightness value calculation unit 1031 of image processing unit 103 calculates a brightness of the background image stored in image data storage unit 102 (step S203). Brightness value calculation unit 1031 calculates, for example, a brightness V in an HSV model as V=max(r, g, b), from an RGB value (r, g, b) of the background image.

Brightness value determination unit 1032 determines whether a calculated brightness value is equal to or above a predetermined threshold (step S204). Brightness value determination unit 1032 determines, for example, whether an average value of the brightness value of the background image is equal to or above a medium value of the brightness. For example, when the brightness is expressed in 256 tones, the unit determines whether the average value of the brightness value of the background image is equal to or above 127.

As a result of determination, when the average value is equal to or above the threshold (YES in step S204), brightness value reduction unit 1034 reduces the brightness of the background image. Brightness value reduction unit 1034 performs, for example, a negative/positive conversion for the background image. When the brightness is expressed in 256 tones, a value of the brightness should be equal to a value obtained by subtracting an original brightness from 255 (step S205).

Background image conversion unit 1035 converts the background image or the background image in which the brightness is reduced in brightness value reduction unit 1034 (step S206). Background image conversion unit 1035 uses, for example, the brightness value V (0 to 255) of the background image and an HSV value (h, s, v) of the theme color to specify an HSV value of the converted background image to (h, s, V). Background image conversion unit 1035 makes a color phase H and a saturation S of the converted background image identical to a color phase and a saturation of the theme color to specify the brightness of the converted background image to a brightness of the background image.

Foreground image acquisition unit 105 acquires via in-vehicle LAN 1001 a foreground image specified by a user (step S207). Combining unit 1036 combines the foreground image and the converted background image so that the background image converted in step S206 will be the background image in the area of the foreground image specified by the user (step S208).

The combined image is stored in output image storage unit 104. Display unit 107 displays the image stored in output image storage unit 104 (step S209), and then the process once ends.

Once a converted background image is generated, a display screen can be combined, by storing the converted background image in, for example, image data storage unit 102, without performing a calculation process (step S203) for a brightness of a background image, a brightness determination process (step S204), and a reduction process (step S205) for a brightness value of the background image.

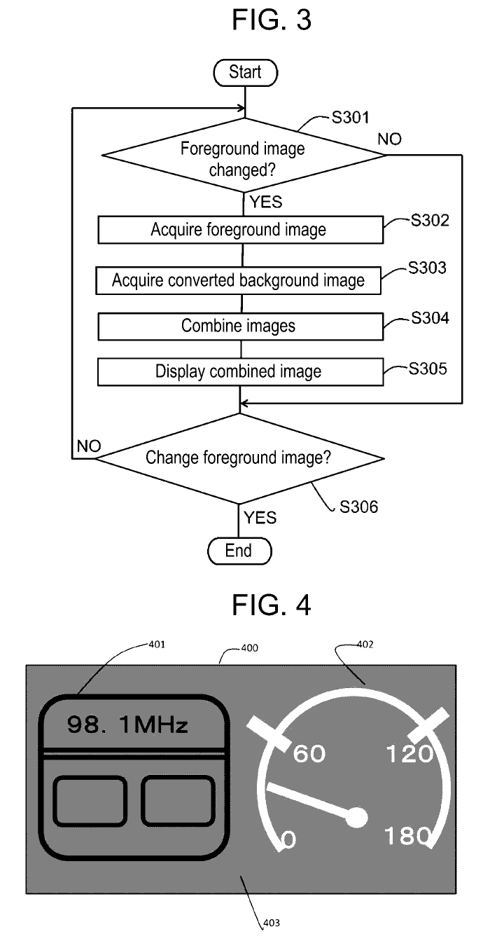

FIG. 3 is a flow chart illustrating an exemplary operation of vehicle-mounted display device 100 after a background image is converted. Control unit 108 determines whether a foreground image is changed. For example, when the foreground image includes a fuel meter, and a meter of the fuel meter is moved as fuel is consumed, control unit 108 determines that the foreground image is changed (step S301).

When the foreground image is changed, foreground image acquisition unit 105 acquires the changed foreground image via in-vehicle LAN 1001 (step S302). Image processing unit 103 acquires a converted background image stored in image data storage unit 102 (step S303). Combining unit 1036 combines the foreground image and the converted background image (step S304). The combined image is stored in output image storage unit 104. Display unit 107 displays the image stored in output image storage unit 104 (step S305). If the foreground image is not changed, the operation proceeds to step S306.

Control unit 108 determines whether a user has instructed display of another foreground (step S306). When the user has instructed display of another foreground, the operation ends. When no display of another foreground is instructed, the operation returns to step S301.

Next, a major process performed by vehicle-mounted display device 100 using a foreground image, a user image to be treated as a background image, and a display screen to be displayed on display unit 107 will now be described herein.

FIG. 4 is a view illustrating an exemplary foreground image. Foreground image 400 includes image 401 that is a display screen displaying an audio and other information, and speedometer 402 displaying a vehicle speed that is part of vehicle information. In image 401, for example, 98.1 MHz represents a frequency at which a radio is receiving.

Foreground image 400 provides an image having a sense of uniformity as a whole with image 401 and color 403 of other than speedometer 402. In the first exemplary embodiment, color 403 is used as a theme color.

A major process performed by vehicle-mounted display device 100 will now be described herein with reference to an example in which a background image will be displayed on speedometer 402.

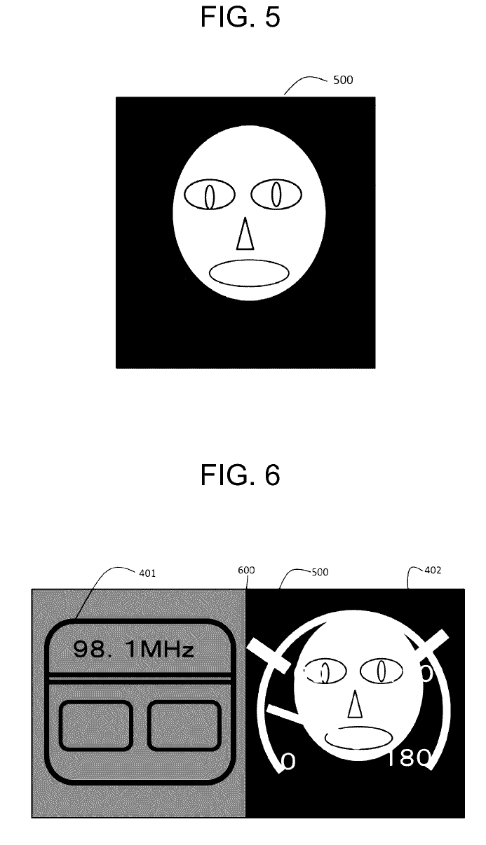

FIG. 5 is a view illustrating an exemplary user image to be treated as a background image. FIG. 6 is a view illustrating image 600 in which foreground image 400 and background image 500 are simply combined. Almost no numerals 60, 120 shown on speedometer 402 can be recognized. Visibility of speedometer 402 itself is also lowered.

In vehicle-mounted display device 100 according to the exemplary embodiment of the present invention, background image conversion unit 1035 converts a background image using color information of a theme color. Combining unit 1036 combines a background image converted by background image conversion unit 1035, and a foreground image.

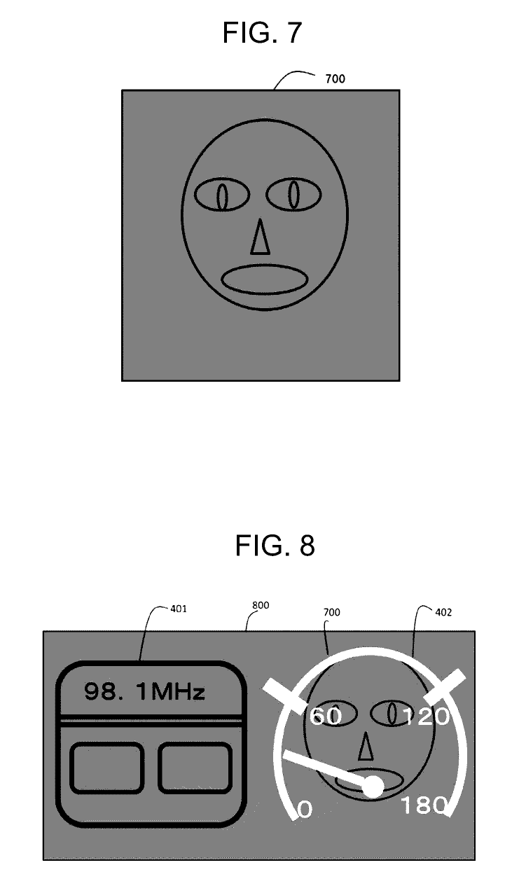

FIG. 7 is a view illustrating an exemplary background image converted by background image conversion unit 1035. Background image conversion unit 1035 makes a color phase H and a saturation S of background image 500 identical to a color phase and a saturation of a theme color (color 403) to convert background image 500 into background image 700.

FIG. 8 is a view illustrating an image in which converted background image 700 and foreground image 400 are combined. Image 800 shown in FIG. 8 is a display image displayed on display unit 107. Image 800 is an image in which, when image 800 is compared with image 600 in which foreground image 400 and background image 500 each shown in FIG. 6 are simply combined, numerals 60, 120 of speedometer 402 and background image 500 respectively can easily be viewed, and a higher sense of uniformity is provided through a theme color.

As described above, vehicle-mounted display device 100 according to the exemplary embodiment can provide a sense of uniformity on a whole display screen so that a background image that does not reduce visibility of a foreground image is displayed regardless of whether the background image has a color similar to a color of the foreground image.

By providing a sense of uniformity on a whole screen, the display device prevents eyes of a driver from being focused on a background image while driving a vehicle.

A brightness calculated as V of an HSV model herein is referred to as a value indicating a degree of lightness in which white is specified to a maximum value, while black is specified to a minimum value. Such a value may be calculated as L in an HSL model, or Y in a YCbCr model, or, otherwise as an average value between Y and V. A method for calculating a brightness value is not limited to the above described method, but other methods may be used.

In addition, although a brightness of a background image is used as a brightness of a converted background image, for example, an HSV value of the converted background image may be calculated by (h, s, v×V/255), under which a brightness value of a theme color is specified to a maximum value so as to take into account a brightness of the theme color. A value acquired in such a manner can provide a sense of uniformity with regard to brightness even if a theme color is darker.

In addition, although brightness value reduction unit 1034 has performed a negative/positive conversion for a background image to reduce a brightness, a method through which a brightness of a background image is evenly reduced may be used to reduce the brightness. This method is advantageous, compared with negative/positive conversion, because an impression of an original image can be left remained.

In addition, when an input background image is configured with a main object and its background, a background might have a lighter color. At this time, if the image is unified into a color phase of a theme color, a main view object could be difficult to see. In such a case, the main object can easily be viewed by converting a color of the background into a darker color even though the image is unified into a color phase of a theme color.

For example, when colors of four corners of a background image match, a method may be applied, through which portions of areas successive to the corners with an identical or similar color will be converted into black (minimum brightness value, a brightness value of 0). By darkening the background of the background image, a main view object in the background image can be clearly displayed as the background image.

In addition, background image conversion unit 1035 may be configured to convert a background image by specifying a color phase value of the background image to a color phase value closer to the color phase value of the background image within a predetermined range around a color phase value of a theme color to make a saturation value of the background image as a saturation value of an input background image.

By specifying a color phase value in a predetermined range, for example, a range within five degrees around a color phase value of a theme color, a background image can be an image in which an original background image is further reflected, while visibility is maintained.

For example, when a color phase H value is specified to a value in a range of 0 degrees≦H<360 degrees, an HSV value of a background image is specified to (H, S, V), and an HSV value of a theme color is specified to (h, s, v), h′ may be acquired with H−h (h′ is corrected so as to fall within −180 degrees≦h′<180 degrees), and an HSV value of a converted image may be acquired with (5h′/180 degrees+h, S, V).

In addition, although background image conversion unit 1035 is configured such that, as a color phase component of a theme color, HS in an HSV model is made identical to HS of a background image, background image conversion unit 1035 may be configured such that, as a color phase component, only H of an HSV model is used as H of a background image.

In addition, an HSL model may be configured such that H of a background image is H, a color phase component of a theme color, and HS of the background image is HS, another color phase component of the theme color.

In addition, a YCrCb model may be configured such that Cr of a background image is Cr, a color phase component of a theme color, and CrCb of the background image is CrCb, another color phase component of the theme color.

In addition, an HSL model and a YCrCb model may be configured such that a color phase component of a background image is a color phase component closer to the color phase component of the background image within a predetermined range around a color phase component of a theme color.

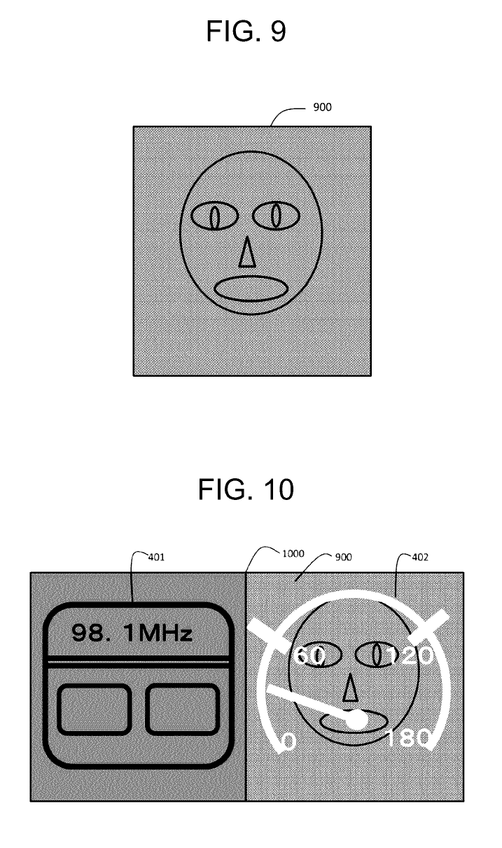

FIG. 9 is a view illustrating another example of the converted background image. Background image 900 is a background image converted from background image 500 by specifying a color phase value of background image 500 to a color phase value closer to the color phase value of the background image within a predetermined range around a color phase value of a theme color to make a saturation value of the background image as a saturation value of a theme color.

FIG. 10 is a view illustrating image 1000 in which converted background image 900 and foreground image 400 shown in FIG. 4 are combined. Image 1000 shown in FIG. 10 is an image into which, when image 1000 is compared with image 800 shown in FIG. 8, background image 500 shown in FIG. 5 is further reflected. Image 1000 is an image in which, when image 1000 is compared with image 600 shown in FIG. 6, numerals 60, 120 of a speedometer and a background image can easily be viewed, and a higher sense of uniformity is provided.

In addition, input unit 101 having a communication function via an internet may be configured so that a background image is input via the internet. Input unit 101 having a memory reading function may be configured so that a background image is input from a memory.

The display device may be configured so that a theme color is stored in an image processing unit beforehand. The display device may be configured so that a theme color is input from input unit 101.

In addition to achieving vehicle-mounted display device 100 according to the exemplary embodiment of the present invention with special hardware, the display device may be a one in which a program for achieving functions of the display device is stored in a computer-readable storage medium to allow a computer to read and execute the stored program.

### INDUSTRIAL APPLICABILITY

A vehicle-mounted display device according to the present invention is useful as a display device for displaying vehicle information and other information to a driver.

### REFERENCE MARKS IN THE DRAWINGS

100 vehicle-mounted display device
101 input unit
102 image data storage unit
103 image processing unit
104 output image storage unit
105 foreground image acquisition unit
106 theme color acquisition unit
107 display unit
108 control unit
400 foreground image
401 image
402 speedometer
403 color
500 background image
600 image
700 background image
800 image
900 background image
1000 image
1001 in-vehicle LAN
1031 brightness value calculation unit
1032 brightness value determination unit
1034 brightness value reduction unit
1035 background image conversion unit
1036 combining unit

1. A vehicle-mounted display device comprising:
an input unit for inputting a background image;
a foreground image acquisition unit for acquiring a foreground image including vehicle information;
a brightness value calculation unit for calculating a brightness value of the input background image;
a background image conversion unit for converting the background image using the brightness value and color information of a theme color, the brightness value being calculated by the brightness value calculation unit;
a combining unit for combining the background image and the foreground image, the background image being converted by the background image conversion unit; and
a display unit for displaying an image combined by the combining unit.

2. The vehicle-mounted display device according to claim 1, wherein the background image conversion unit makes a color phase component of the background image identical to a color phase component of the theme color.

3. The vehicle-mounted display device according to claim 1, wherein the background image conversion unit specifies a color phase component of the background image to a color phase component closer to the color phase component of the background image within a predetermined range around a color phase component of the theme color.

4. The vehicle-mounted display device according to claim 2, wherein a color phase component of the converted background image is H of an HSV model.

5. The vehicle-mounted display device according to claim 3, wherein a color phase component of the converted background image is H of an HSV model.

6. The vehicle-mounted display device according to claim 2, wherein a color phase component of the converted background image is H of an HSL model.

7. The vehicle-mounted display device according to claim 3, wherein a color phase component of the converted background image is H of an HSL model.

8. The vehicle-mounted display device according to claim 2, wherein a color phase component of the converted background image is Cr of a YCrCb model.

9. The vehicle-mounted display device according to claim 3, wherein a color phase component of the converted background image is Cr of a YCrCb model.

10. The vehicle-mounted display device according to claim 1, wherein the background image conversion unit makes the brightness value of the background image identical to a brightness value of the converted background image.

11. The vehicle-mounted display device according to claim 1, further comprising:
a brightness value determination unit for comparing the brightness value of the background image with a threshold; and
a brightness value reduction unit for reducing the brightness value of the background image in accordance with a result of determination performed by the brightness value determination unit,
wherein the background image conversion unit converts the background image in which the brightness value is reduced.

12. The vehicle-mounted display device according to claim 1, further comprising a theme color acquisition unit for acquiring a theme color of a vehicle,
wherein the background image conversion unit converts the background image using the theme color acquired by the theme color acquisition unit.

13. A method for controlling a vehicle-mounted display device, the method comprising the steps of:
inputting a background image;
acquiring a foreground image including vehicle information;
calculating a brightness value of the input background image;
converting the background image using the brightness value of the calculated background image and color information of a theme color;
combining the converted background image and the foreground image; and
displaying the combined image.

14. A method for controlling the vehicle-mounted display device according to claim 11, wherein, when the background image is converted, a color phase component of the background image is made identical to a color phase component of the theme color.

15. A method for controlling the vehicle-mounted display device according to claim 11, wherein, when the background image is converted, a color phase component of the background image is made identical to a color phase component closer to the color phase component of the background image within a predetermined range around a color phase component of the theme color.

16. (canceled)
